(19) United States
(12) Patent Application Publication
(10) Pub. No.: US 2021/0058531 A1
(43) Pub. Date: Feb. 25, 2021

(54) PRINTER AND PRINTING CONTROL METHOD

(71) Applicant: Mitsubishi Electric Corporation, Tokyo (JP)

(72) Inventor: Junko SHINOHARA, Tokyo (JP)

(73) Assignee: Mitsubishi Electric Corporation, Tokyo (JP)

(21) Appl. No.: 16/965,480

(22) PCT Filed: Mar. 26, 2018
(86) PCT No.: PCT/JP2018/012055

§ 371 Date: Jul. 28, 2020

(51) Int. Cl. H04N 1/387; H04N 1/047; G06K 15/02

(52) U.S. Cl. CPC H04N 1/3872; G06K 15/1822; H04N 1/0473

(57) ABSTRACT

An image generation control unit generates a connection image indicating a plurality of print target images. The connection image is an image for being printed using a first region for being used in the n-th printing processing and a second region for being used in the (n+1)-th printing processing. An image processing unit generates a first image for being printed using the first region and a second image for being printed using the second region.

### TECHNICAL FIELD

The present invention relates to a printer for printing a plurality of images and a printing control method.

### BACKGROUND ART

In general, a thermal transfer printer controls heat generation of a thermal head while conveying an ink sheet and paper with the ink sheet and the paper sandwiched by a thermal head and a platen roller. Thus, the ink on the ink sheet is transferred to the paper for each line, and an image is formed on the paper.

Hereinafter, yellow, magenta, and cyan are also referred to as “Y”, “M”, and “C”, respectively. In addition, hereinafter, the overcoat layer is also referred to as “OP layer” or “OP”. In addition, hereinafter, the Y component image is also referred to as “Y image”. In addition, hereinafter, the M component image is also referred to as “M image”. In addition, hereinafter, the C component image is also referred to as “C image”. In addition, hereinafter, of the paper, the region for forming an image is also referred to as “printing region”.

The thermal transfer printer forms a Y image, an M image, and a C image in the printing region of the paper in the order of the Y image, the M image, and the C image, and then transfers the OP layer to the printing region. This improves the light resistance and the fingerprint resistance of the printed matter.

When a thermal transfer printer prints a photograph, the types of ink sheets to be used are limited in order to shorten the printing time and prevent an increase in cost. Thus, a technique for performing printing using a large-format sized ink sheet has been proposed.

Japanese Patent Application Laid-Open No. 2007-090798 discloses a configuration for printing a plurality of small images using a large-format sized ink sheet (hereinafter, also referred to as “related configuration A”).

Hereinafter, the size of a component whose horizontal size is u inches and whose vertical size is v inches is also expressed as “u×v size”. Each of the “u” and the “v” is a natural number. In addition, hereinafter, an image of u×v size is also referred to as “u×v size image”. For example, a 6×4 size image is an image having a horizontal size of 6 inches and a vertical size of 4 inches. In addition, hereinafter, an ink sheet of u×v size is also referred to as “u×v size ink sheet”.

In addition, hereinafter, a printer capable of printing a 6×4 size image and a 6×8 size image is also referred to as a “multiple size compatible printer”. The multiple size compatible printer can print three 8×4 size images using an 8×12 size ink sheet, for example.

In addition, the multiple size compatible printer can print two 6×4 size images using a 6×8 size ink sheet, for example. The configuration for printing two 6×4 size images can reduce the time required for processing other than the heating treatment as compared with the configuration for printing 6×4 size images one by one. The heating treatment is treatment for applying energy to the thermal head.

However, when an odd number of 6×4 size images using a 6×8 size ink sheet are printed, a fraction loss occurs in the ink sheet.

Thus, in the related configuration A, the following processing is performed. First, after the printing of the first image is completed, the ink sheet is rewound in response to receiving the next print job (print command). Next, the second image is printed using the non-printed portion of the ink sheet. The non-printed portion is, of the regions of the ink sheet to be used in one time of printing, some regions not used when the first image is printed.

Hereinafter, processing for printing an image on paper is also referred to as “printing processing”. In addition, hereinafter, of the ink sheet, a region to be used in one time of printing processing is also referred to as “region Rt1”. The size of the region Rt1 corresponds to the size of the region of the ink sheet used to print the image of the maximum size that can be generated in one time of printing processing. In addition, hereinafter, an image to be printed is also referred to as “print target image”.

### SUMMARY

### Problem to be Solved by the Invention

The related configuration A is a configuration for printing a plurality of print target images. However, in the related configuration A, a print target image having a size larger than the size of the region Rt1 (hereinafter, also referred to as a “large image”) cannot be printed. It should be noted that the size of the print target image may be different from the size of the region Rt1 in some cases.

Thus, it may be requested to generate a plurality of images for printing a large image showing a plurality of print target images including a print target image having a size different from the size of the region Rt1 in a plurality of times of printing processing.

The present invention has been made to solve such a problem, and has an object to provide a printer or the like capable of generating a plurality of images for printing a large image showing a plurality of print target images in a plurality of times of printing processing.

### Means to Solve the Problem

In order to achieve the above object, a printer according to one aspect of the present invention performs printing processing of printing an image using an ink sheet. The ink sheet has a first region for being used in the n-th (natural number of one or more) printing processing and a second region for being used in the (n+1)-th printing processing. The printer performs processing using a plurality of print target images. A size of one or more print target images included in the plurality of print target images is different from a size of the first region. The printer includes:
an image generation control unit configured to generate, using the plurality of print target images, a connection image being an image for being printed using the first region and the second region, the connection image indicating the plurality of print target images; and
an image processing unit configured to generate, using the connection image, a first image included in the connection image for being printed using the first region, and a second image included in the connection image for being printed using the second region.

### Effects of the Invention

According to the present invention, the image generation control unit generates a connection image indicating the plurality of print target images. The connection image is an image for being printed using the first region for being used in the n-th printing processing and the second region for being used in the (n+1)-th printing processing. The image processing unit generates a first image for being printed using the first region and a second image for being printed using the second region.

Thus, it is possible to generate a plurality of images for printing, by the printing processing in a plurality of times, a large image (connection image) indicating a plurality of printing target images.

The objects, characteristics, aspects, and advantages of the present invention will become more apparent from the following detailed description and the accompanying drawings.

### BRIEF DESCRIPTION OF DRAWINGS

FIG. 1 is a block diagram showing a main configuration of a printer according to a first embodiment.

FIG. 2 is a diagram illustrating a configuration of a printing unit.

FIG. 3 is a diagram for illustrating an ink sheet.

FIGS. 4A and 4B are diagrams showing a region included in the ink sheet and an image.

FIG. 5 is a diagram showing states of three types of regions of the ink sheet when printing processing is performed.

FIG. 6 is a diagram for illustrating a connection image.

FIGS. 7A, 7B, and 7C are diagrams for illustrating the connection image in detail.

FIG. 8 is a flowchart of print control processing according to the first embodiment.

FIG. 9 is a flowchart of print data generation processing.

FIG. 10 is a diagram showing an example of a print target image.

FIG. 11 is a flowchart of print data generation processing according to a first modification.

FIG. 12 is a diagram showing an example of the connection image.

FIG. 13 is a diagram showing an example of the connection image in a replacement state.

FIG. 14 is a diagram showing an example of an image generation definition table according to a second modification.

FIG. 15 is a block diagram showing a main configuration of a printer according to the second embodiment.

FIG. 16 is a block diagram illustrating a characteristic functional configuration of the printer.

FIG. 17 is a hardware configuration diagram of the printer.

FIG. 18 is a diagram showing states of three types of regions of an ink sheet in a comparative example.

### DESCRIPTION OF EMBODIMENTS

Hereinafter, embodiments of the present invention will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions and shape of each component, relative arrangement of each component, and the like exemplified in the embodiments may be appropriately changed according to the configuration, various conditions, and the like of the apparatus to which the present invention is applied.

### First Embodiment

### Configuration

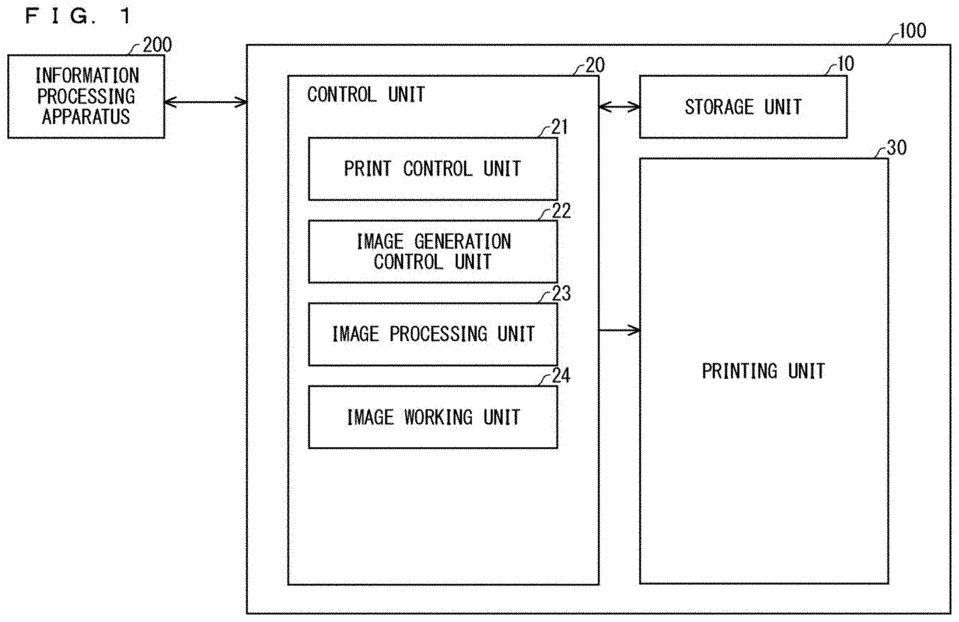

FIG. 1 is a block diagram showing a main configuration of a printer 100 according to the first embodiment. It should be noted that FIG. 1 does not show components (such as a power supply) not related to the first embodiment. It should be noted that FIG. 1 also shows an information processing apparatus 200 not included in the printer 100 for the sake of illustration. The printer 100 is a thermal transfer printer, for example. The printer 100 performs printing processing P for printing an image on paper, which will be described in detail below.

The information processing apparatus 200 is an apparatus that controls the printer 100. The information processing apparatus 200 is a personal computer (PC), for example. The information processing apparatus 200 is operated by a user. When the user performs a print execution operation on the information processing apparatus 200, the information processing apparatus 200 transmits print instructions and image data D1 to the printer 100. The print execution operation is an operation for causing the printer 100 to execute the printing processing P. In addition, the print instructions are instructions for causing the printer 100 to execute the printing processing P. The image data D1 is data on an image for being printed on paper. The image shown by the image data D1 includes a Y image, an M image, and a C image.

The printer 100 includes a storage unit 10, a control unit 20, and a printing unit 30. The storage unit 10 has a function of storing various types of data. The storage unit 10 includes an image memory M1 and a memory M2. The image memory M1 has a function of storing an image. The memory M2 stores a program such as a control program.

The control unit 20 performs various types of processing on each unit of the printer 100, which will be described in detail below. The control unit 20 is a processor such as a central processing unit (CPU), for example.

The control unit 20 includes a print control unit 21, an image generation control unit 22, an image processing unit 23, and an image working unit 24. All or a part of the print control unit 21, the image generation control unit 22, the image processing unit 23, and the image working unit 24 are program modules executed by the control unit 20, for example. In other words, all or a part of the print control unit 21, the image generation control unit 22, the image processing unit 23, and the image working unit 24 are achieved by the control unit 20 performing various types of processing according to software programs stored in a memory or the like.

It should be noted that all or a part of the print control unit 21, the image generation control unit 22, the image processing unit 23, and the image working unit 24 may include a signal processing circuit including a hardware electric circuit.

The print control unit 21 has a function of controlling the printing unit 30, which will be described in detail below. The processing performed by each of the image generation control unit 22, the image processing unit 23, and the image working unit 24 will be described below.

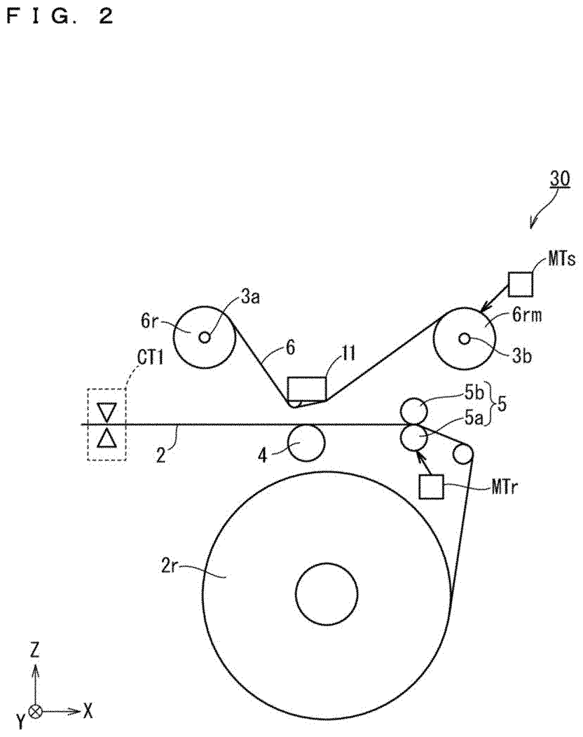

FIG. 2 is a diagram illustrating a configuration of the printing unit 30. FIG. 2 shows a configuration of the printing unit 30 in a state where the roll paper 2r and the ink sheet 6 are mounted on the printer 100. The roll paper 2r is configured by long paper 2 being wound into a roll shape.

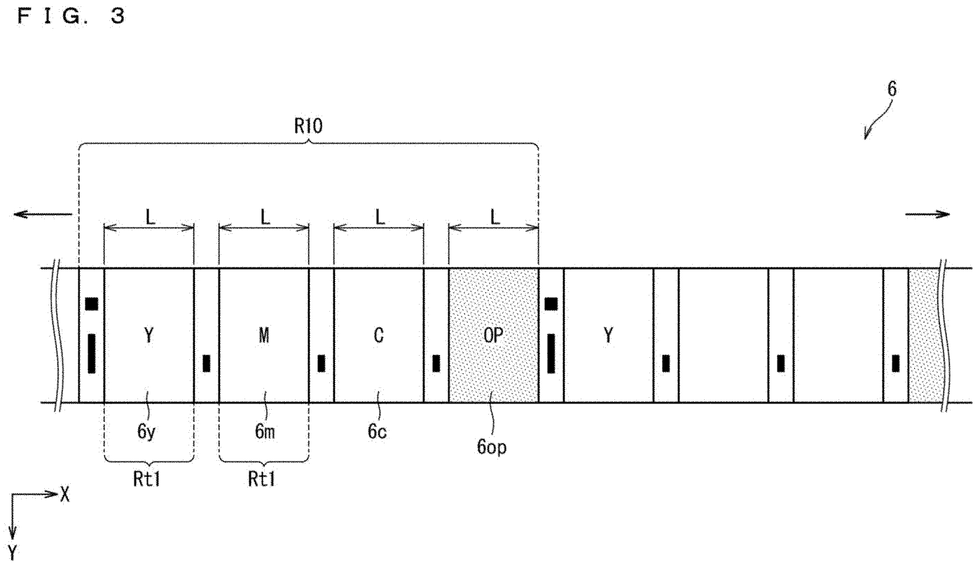

The ink sheet 6 is a long sheet. FIG. 3 is a diagram for illustrating the ink sheet 6. In FIG. 3, the X direction and the Y direction are orthogonal to each other. The X direction and the Y direction illustrated in the following drawings are also orthogonal to each other. Hereinafter, a direction including the X direction and a direction opposite to the X direction (−X direction) is also referred to as “X-axis direction”. In addition, hereinafter, a direction including the Y direction and a direction opposite to the Y direction (−Y direction) is also referred to as “Y-axis direction”. In addition, hereinafter, a plane including the X-axis direction and the Y-axis direction is also referred to as “XY plane”.

In FIG. 3, the −X direction is a direction toward an ink roll 6rm described below. In addition, in FIG. 3, the X direction is a direction toward an ink roll 6r described below. The detailed description of the ink sheet 6 will be given below.

With reference to FIG. 2, the printing unit 30 includes a thermal head 11, a conveyance roller pair 5, a platen roller 4, bobbins 3a and 3b, motors MTs and MTr, and a cutter CT1.

The thermal head 11 has a function of emitting heat.

The conveyance roller pair 5 is a roller pair for conveying the paper 2. The conveyance roller pair 5 includes a grip roller 5a and a pinch roller 5b. The conveyance roller pair 5 is configured to convey the paper 2 by rotating the grip roller 5a in a state of the paper 2 sandwiched between the grip roller 5a and the pinch roller 5b.

One end of the ink sheet 6 is attached to the bobbin 3a. The other end of the ink sheet 6 is attached to the bobbin 3b. Winding one end of the ink sheet 6 around the bobbin 3a forms an ink roll 6r. Winding the other end of the ink sheet 6 around the bobbin 3b forms an ink roll 6rm.

The ink roll 6r is a roll for supplying the ink sheet 6. The ink roll 6rm is a roll for taking up the ink sheet 6.

The bobbin 3b rotates so as to take up the ink sheet 6. That is, along with the rotation of the bobbin 3b, the ink roll 6rm rotates so as to take up the ink sheet 6. It should be noted that the ink roll 6r also rotates along with the rotation of the ink roll 6rm. Therefore, as the ink roll 6rm takes up a part of the ink sheet 6, the ink roll 6r supplies the ink sheet 6 by the length of the taken-up ink sheet 6.

The platen roller 4 is provided so as to face a part of the thermal head 11. The platen roller 4 is movably configured so that the ink sheet 6 and the paper 2 can be sandwiched by the platen roller 4 and the thermal head 11. The platen roller 4 comes into contact with the thermal head 11 with the paper 2 and the ink sheet 6 interposed therebetween.

Hereinafter, the state of the platen roller 4 when the platen roller 4 is in contact with the thermal head 11 with the paper 2 and the ink sheet 6 interposed therebetween is also referred to as “platen contact state”. The platen contact state is a state in which the paper 2 and the ink sheet 6 are sandwiched between the platen roller 4 and the thermal head 11.

In the platen contact state, heating the ink sheet 6 by the thermal head 11 transfers the dye (ink) of the ink sheet 6 to the paper 2.

Each of the motors MTs and MTr is driven by a pulse (signal), which will be described in detail below. The motor MTs is a motor for rotating the bobbin 3b (ink roll 6rm). The print control unit 21 controls the motor MTs so that the ink sheet 6 is conveyed.

The motor MTr is a motor for rotating the grip roller 5a. The print control unit 21 controls the motor MTr so that the paper 2 is conveyed.

The cutter CT1 has a function of cutting a part of the paper 2.

Referring to FIG. 3 again, in the ink sheet 6, ink regions R10 are periodically arranged along the longitudinal direction (X-axis direction) of the ink sheet 6.

The ink region R10 is provided with dyes 6y, 6m, and 6c and a protective material 6op. Each of the dyes 6y, 6m, and 6c and the protective material 6op is a transfer material transferred to the paper 2 by being heated by the thermal head 11. Each of the dyes 6y, 6m, and 6c shows a color to be transferred to the paper 2. The dyes 6y, 6m, and 6c show colors of yellow, magenta, and cyan, respectively. In addition, hereinafter, each of the Y dye, the M dye, and the C dye is also referred to as “color dye”.

The protective material 6op is a material for protecting the color transferred to the paper 2 (overcoat). Specifically, the protective material 6op is a material for protecting the image formed on the paper 2 by the dyes 6y, 6m, and 6c. Hereinafter, the protective material 6op is also referred to as “OP material”. In addition, hereinafter, of the paper 2, the region for forming an image is also referred to as “printing region”.

In the printing processing P, unit printing processing is performed. In the unit printing processing, the ink sheet 6 and the paper 2 are simultaneously conveyed while the thermal head 11 heats the transfer material of the ink sheet 6 in the platen contact state. Thus, the transfer material is transferred to the printing region of the paper 2 for each line.

The unit printing processing described above is repeatedly performed on each of the dyes 6y, 6m, and 6c and the protective material 6op being transfer materials, whereby the dyes 6y, 6m, and 6c and the protective material 6op are transferred to the printing region of the paper 2 in the order of the dyes 6y, 6m, and 6c and the protective material 6op. As a result, an image is formed in the printing region of the paper 2, and the image is protected by the protective material 6op. That is, the printing processing P is processing of printing an image on the paper 2 using the ink sheet 6.

Hereinafter, the image formed in the printing region of the paper 2 is also referred to as “image Gn”. In addition, hereinafter, the direction in which the paper 2 is conveyed is also referred to as “paper conveying direction”. In FIG. 3, the paper conveying direction is the X-axis direction including the X direction and the −X direction.

The direction in which the printer 100 forms an image on the paper 2 includes a main scanning direction and a sub-scanning direction. The sub-scanning direction is the paper conveying direction. In addition, the main scanning direction is a direction orthogonal to the sub-scanning direction. Hereinafter, the paper conveying direction is also referred to as “direction Drp”.

In addition, hereinafter, in the ink sheet 6, a region where each of the dyes 6y, 6m, and 6c and the protective material 6op is provided is also referred to as “region Rt1” or “Rt1”. The region Rt1 is a region of the ink sheet 6 used for printing an image of the maximum size that can be generated in one time of printing processing P. The size of the region Rt1 corresponds to the size of one screen corresponding to the image Gn. Hereinafter, the size of the region Rt1 is also referred to as “one screen size”.

In addition, hereinafter, the length of the region Rt1 in the sub-scanning direction (X-axis direction) is also referred to as “length L” or “L”. The length L is predetermined. Therefore, when the ink sheet 6 is used, the upper limit of the length of the image Gn in the sub-scanning direction is the length L.

### Operation of Printer

The information processing apparatus 200 transmits the image data D1 to the printer 100 as a job. The job is unit data for a printer to perform processing. The job is generated by a printer driver, printer control software, or the like. Under the control of the operation system or the application, it is checked whether or not the printer 100 is in a state of being ready to receive a job.

In a state where the printer 100 is ready to receive a job, jobs are sequentially transmitted to the printer 100. In order that a plurality of images can be printed consecutively, the image memory M1 of the storage unit 10 has a capacity capable of storing the plurality of images.

Each time receiving a job, the printer 100 causes the image memory M1 to store the job. The printer 100 causes the image memory M1 to store a maximum number of jobs that the image memory M1 can store.

Next, processing using the large-format sized ink sheet 6 will be described. The large-format size is 6×8 size, for example. Hereinafter, the large-format sized ink sheet 6 is also referred to as “large ink sheet”. In addition, hereinafter, a size larger than 0.5 times the large-format size is also referred to as “half excess size”. In addition, hereinafter, the printer having the above-described related configuration A is also referred to as “printer J1”.

Here, a comparative example to be compared with the present embodiment will be described. The printer in the comparative example is a printer J1. In the comparative example, the following premise Pm1 is considered. In the premise Pm1, the printer J1 performs printing processing P for printing a plurality of half-excess-sized images using a large ink sheet. The printer J1 does not rewind the ink sheet 6 when printing an image of the half excess size.

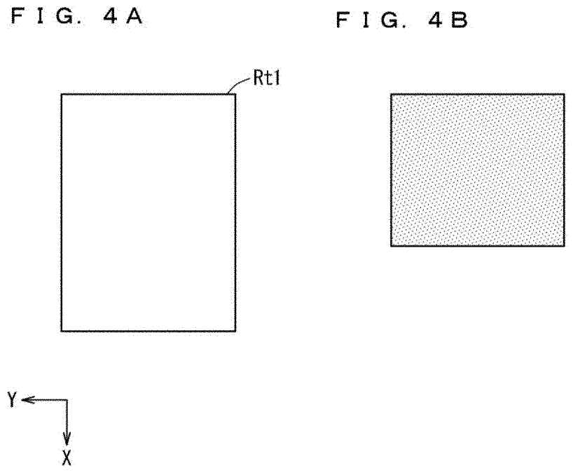

In addition, in the premise Pm1, the size (one screen size) of the region Rt1 in the large ink sheet is 6×8 size. That is, in the premise Pm1, the large ink sheet is a 6×8 size ink sheet. FIG. 4A shows a region Rt1 of the 6×8 size ink sheet. The region Rt1 in FIG. 4A corresponds to each region Rt1 in one ink region R10 in FIG. 3.

In addition, in the premise Pm1, the half excess size is 6×5 size. FIG. 4B shows a 6×5 size image. In addition, in the premise Pm1, the printer J1 performs printing processing P for printing 6×5 sized images G1, G2, and G3 using the ink sheet 6. Each of the images G1, G2, and G3 is a print target image.

It should be noted that the printer J1 does not rewind the ink sheet 6 when printing an image of the half excess size. Therefore, the printer J1 forms (prints) the images G1, G2, and G3 on the paper 2 using the three ink regions R10 (three types of regions Rt1) included in the ink sheet 6. In this case, the printing processing P is performed three times.

Hereinafter, the respective three types of regions Rt1 are also referred to as regions Rt1a, Rt1b, and Rt1c. Each of the regions Rt1a, Rt1b, and Rt1c corresponds to a region Rt1 included in a different ink region R10. That is, the ink sheet 6 includes a region Rt1a, a region Rt1b, and a region Rt1c.

The region Rt1a is a region for being used in the n-th printing processing P, for example. “n” is a natural number of one or more. In addition, the region Rt1b is a region for being used in the (n+1)-th printing processing P, for example.

In the comparative example, four regions Rt1a (the dyes 6y, 6m, and 6c and the protective material 6op) are used for printing the image G1. In addition, in the comparative example, four regions Rt1b are used for printing the image G2. In addition, in the comparative example, four regions Rt1c are used for printing the image G3. Hereinafter, in a state where the print target image is printed on the paper 2, the state of the print target image is also referred to as “print state”.

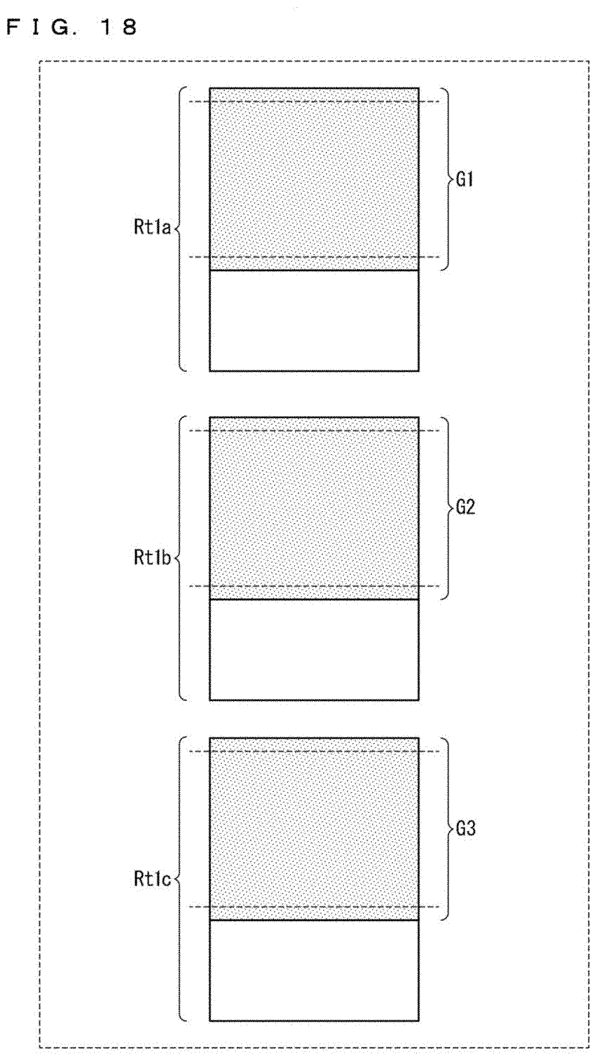

FIG. 18 is a diagram illustrating a state of regions Rt1a, Rt1b, and Rt1c of the ink sheet 6 in the comparative example. That is, FIG. 18 illustrates the states of the regions Rt1a, Rt1b, and Rt1c when the printing processing P in three times is performed in the premise Pm1. Hereinafter, the position to be cut in the print target image in the print state is also referred to as “cut position”. The position indicated by the dotted line in FIG. 18 corresponds to the cut position.

In each of the regions Rt1a, Rt1b, and Rt1c in FIG. 18, the hatched portion is a used portion. The used portion is a portion where the transfer material is used (transferred).

In addition, in each of the regions Rt1a, Rt1b, and Rt1c in FIG. 18, the white portion is an unused portion. The unused portion is a portion where the transfer material is not used (transferred). In the comparative example, as shown in FIG. 18, unused portions having a large area exist in all of the regions Rt1a, Rt1b, and Rt1c. Thus, in the related configuration A, in the comparative example in which the printing processing P to which the premise Pm1 is applied is performed, the unused portion having a large area is a useless region.

Next, a use state of the region Rt1 of the ink sheet 6 in the present embodiment will be described. Here, the following premise Pm1 a is considered. In the premise Pm1a, the printer 100 performs printing processing P for printing a plurality of half-excess-sized images using a large ink sheet. It should be noted that the printing conditions in the premise Pm1a are the same as the printing conditions in the premise Pm1. For example, in the premise Pm1a, the size (one screen size) of the region Rt1 in the large ink sheet is 6×8 size. In addition, in the premise Pm1a, the printer 100 performs printing processing P, using the ink sheet 6, for printing images G1, G2, and G3 of 6×5 size being the print target images.

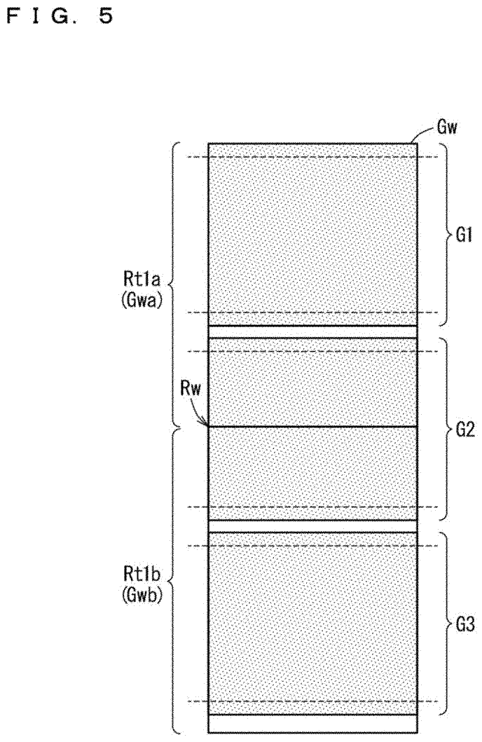

FIG. 5 shows a state of the regions Rt1a, Rt1b, and Rt1c (ink sheet 6) when the printing processing P is performed in the premise Pm1a. The position indicated by the dotted line in FIG. 5 corresponds to the cut position. Although details will be described below, in the present embodiment, an image in which the area of the unused portion in FIG. 18 is very small is generated, and the image is printed. In the following, the processing will be briefly described.

First, a connection image Gw indicating the images G1, G2, and G3 is generated (see FIG. 5). It should be noted that the images G1, G2, and G3 are arranged at intervals. In the present embodiment, in order to make the description easier to understand, an example of generating a connection image Gw will be described using two images. Hereinafter, the two images used for generating the connection image Gw are also referred to as “images Gwa and Gwb”. The connection image Gw includes images Gwa and Gwb.

Next, the image Gwa and the image Gwb are generated based on the size (one screen size) of the ink sheet 6 using the connection image Gw. The image Gwa is a preceding image for being printed first. The image Gwb is a subsequent image for being printed next to the image Gwa.

Then, the images Gwa and Gwb are printed in the order of the images Gwa and Gwb so that the images Gwa and Gwb are connected. The region where the images Gwa and Gwb are connected is a joint region Rw. Details of the joint region Rw will be described below.

Thus, as shown in FIG. 5, the images G1, G2, and G3 of the 6×5 size fall within the combined region of regions Rt1a and Rt1b of the 6×8 size. Therefore, in the premise Pm1a, the printing processing P is performed twice.

Thus, in the present embodiment, images G1, G2, and G3 of the 6×5 size can be printed using the regions Rt1a and Rt1b of the ink sheet 6 without using the region Rt1c. Therefore, in the present embodiment, the unused portion not used in the comparative example can be effectively used. As a result, the used amount of the ink sheet 6 can be reduced.

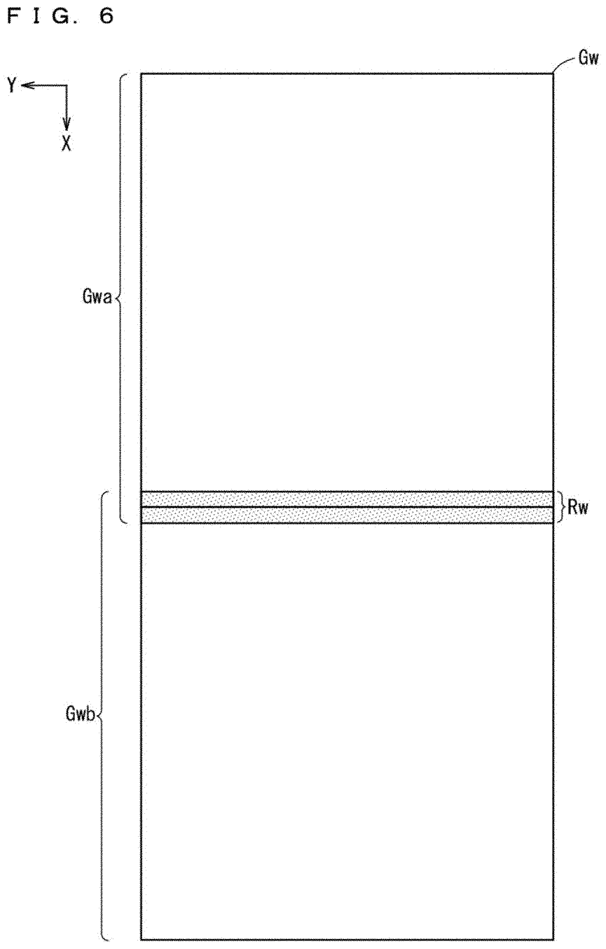

Next, the connection image Gw will be described. FIG. 6 is a diagram for illustrating the connection image Gw. It should be noted that in FIG. 6, the main scanning direction is the Y-axis direction, and the sub-scanning direction is the X-axis direction. The connection image Gw is represented by images Gwa and Gwb. The connection image Gw has a joint region Rw. The joint region Rw is a region for connecting the image Gwa and the image Gwb.

The image Gwa is an image for being printed on the paper 2 using the region Rt1a of the ink sheet 6. The image Gwb is an image for being printed on the paper 2 using the region Rt1b of the ink sheet 6. That is, the connection image Gw is an image for being printed on the paper 2 using the region Rt1a and the region Rt1b of the ink sheet 6.

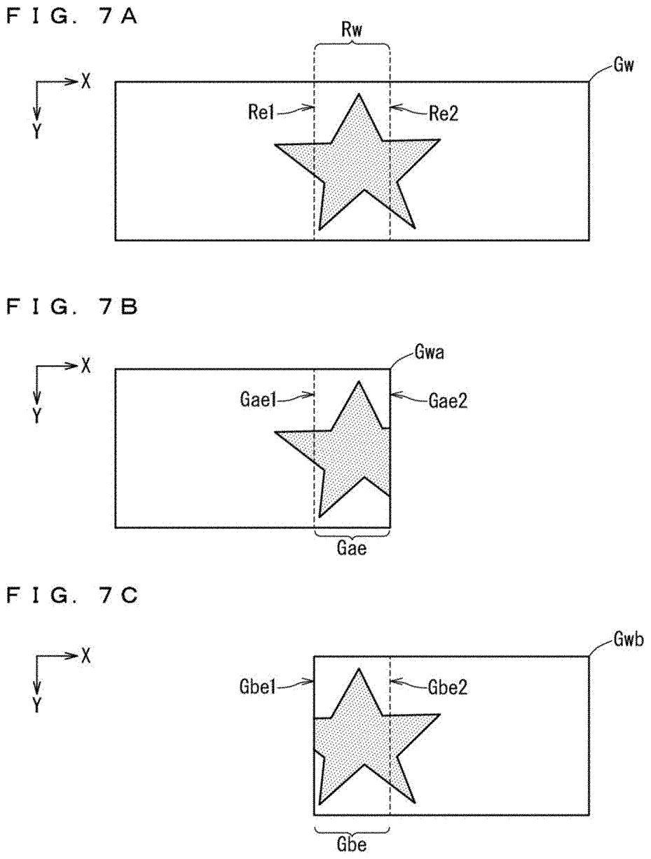

FIGS. 7A, 7B, and 7C are diagrams for illustrating the connection image Gw in detail. It should be noted that in FIGS. 7A, 7B, and 7C, in order to make the configuration of the joint region Rw easy to understand, the joint region Rw is shown larger than the actual size. FIG. 7A is a diagram illustrating an example of the connection image Gw. It should be noted that a star mark is shown in the connection image Gw as an example in order to make it easy to understand the configuration method of the connection image Gw. The image showing the star mark corresponds to the image G2 in FIG. 5, for example. The connection image Gw includes a plurality of pixels. Each pixel is represented by a gradation value (pixel value) indicating the density.

FIG. 7B shows an example of the image Gwa. The image Gwa has an end portion Gae. The end portion Gae is a rear end portion of the image Gwa. The end portion Gae has a front end Gae1 and a rear end Gae2. The rear end Gae2 is a rear end of the image Gwa.

FIG. 7C shows an example of the image Gwb. The image Gwb has an end portion Gbe. The end portion Gbe is a front end portion of the image Gwb. The end portion Gbe has a front end Gbe1 and a rear end Gbe2. The front end Gbe1 is a front end of the image Gwb.

The joint region Rw of the connection image Gw is a region for superimposing the end portion Gbe of the image Gwb on the end portion Gae of the image Gwa. The shape of the joint region Rw is rectangular. The joint region Rw has a front end Re1 and a rear end Re2. The front end Gae1 of the end portion Gae corresponds to the front end Re1 of the joint region Rw. The rear end Gbe2 of the end portion Gbe corresponds to the rear end Re2 of the joint region Rw.

The end portion Gae (rear end portion) of the image Gwa in the print state and the end portion Gbe (front end portion) of the image Gwb in the print state are images of the joint region Rw. The image Gwa is an image printed by the n-th printing processing P. The image Gwb is an image printed by the (n+1)-th printing processing P.

In the present embodiment, the printing processing P is performed so as to superimpose the end portion Gbe on the end portion Gae. In this case, a density step may occur in the joint region Rw due to the characteristics of the thermal transfer printer. That is, when the end portion Gbe is simply superimposed on the end portion Gae, a change in density occurs in the joint region Rw.

Thus, in the present embodiment, image processing is performed to make the density step (density change) inconspicuous. Although details will be described below, in the present embodiment, the image processing for reducing the density change of the joint region Rw that occurs when the end portion Gbe is superimposed on the end portion Gae is performed on the end portion Gae and the end portion Gbe.

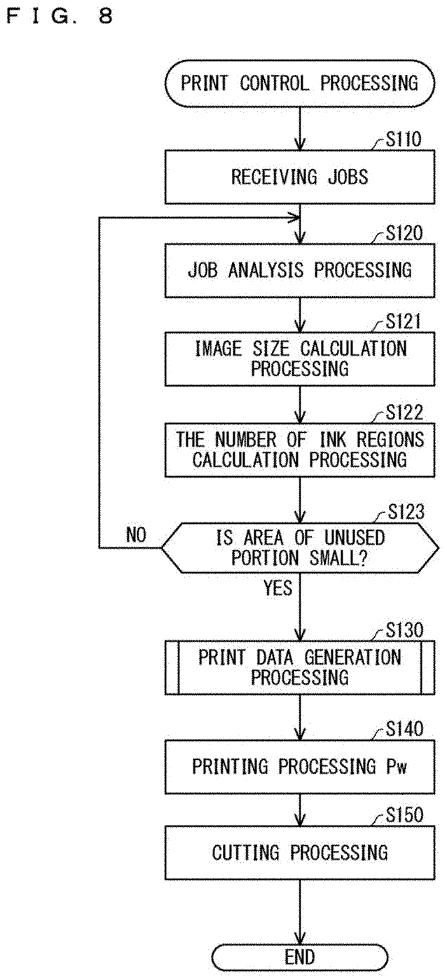

Next, processing performed by the printer 100 (hereinafter, also referred to as “print control processing”) will be described. FIG. 8 is a flowchart of the print control processing according to the first embodiment. In the print control processing, the printer 100 performs processing using k print target images. The “k” is an integer of 2 or more. Each of the k print target images is an independent image. That is, each of the k print target images is an image that independently holds.

In addition, in the print control processing, a connection image Gw is generated using k print target images. It should be noted that the size of one or more print target images included in the k print target images is different from the size of the region Rt1a (region Rt1).

Here, the following premise Pm1b is considered. In the premise Pm1b, k is 3. In addition, in the premise Pm1b, the information processing apparatus 200 sequentially transmits three respective jobs corresponding to three print target images to the printer 100. The three print target images are, for example, the images G1, G2, and G3 in FIG. 5. The size of each of the images G1, G2, and G3 in FIG. 5 is smaller than the size of the region Rt1a (region Rt1). It should be noted that each of the images G1, G2, and G3 includes a Y image, an M image, and a C image.

Each job transmitted to the printer 100 includes image information, a print target image, and the like. The image information is information on a print target image. Hereinafter, the size of the print target image in the direction Drp (paper conveying direction) is also referred to as “size Lgx” or “Lgx”. The image information indicates, for example, the size Lgx or the like of the print target image.

In the print control processing in the premise Pm1b, first, the printer 100 sequentially receives three jobs (step S110).

Next, in step S120, job analysis processing is performed. In the job analysis processing, the image generation control unit 22 refers to the image information included in the s-th job, and specifies the size Lgx or the like of the print target image indicated by the image information. “s” is a natural number of one or more. The initial value of “s” is 1.

Hereinafter, the variable for calculating the total of the sizes Lgx of the print target images included in the analyzed job is also referred to as “size variable Lgxw” or “Lgxw”. The initial value of the size variable Lgxw is 0.

Next, in step S121, image size calculation processing is performed. In the image size calculation processing, the image generation control unit 22 adds the specified size Lgx to the size variable Lgxw.

Hereinafter, the number of ink regions R10 required to print k print target images on the paper 2 is also referred to as “the number N of ink regions” or “N”. “N” is a natural number of one or more. It should be noted that the initial value of N is 1.

Next, in step S122, the number of ink regions calculation processing is performed. In the number of ink regions calculation processing, the number N of ink regions is calculated. Specifically, the image generation control unit 22 calculates the number N of ink regions using the length L of the region Rt1 and the latest size variable Lgxw according to the following Formula 1.

[Formula 1]

Df=L×N−Lgxw (FORMULA 1)

“Df” in Formula 1 corresponds to the size of an unused portion of the region Rt1 in the direction Drp (paper conveying direction). If the size Df is a positive value, the latest L×N value is larger than the latest Lgxw. If the size Df is a negative value, the latest L×N value is smaller than the latest Lgxw.

If the size Df is a negative value, the image generation control unit 22 adds 1 to the value of N. It should be noted that if the size Df is a positive value, the image generation control unit 22 does not change the value of N.

Next, in step S123, the image generation control unit 22 determines whether or not the area of the unused portion is small. The area of the unused portion is the area of the unused portion of the region Rt1 when the printing processing P described below is performed.

Specifically, the image generation control unit 22 determines whether the size Df obtained by substituting the latest value of N into Formula 1 is not more than a specified value Th1. The specified value Th1 is a value for determining the area of the unused portion. The smaller the specified value Th1, the smaller the area of the unused portion. The specified value Th1 is, for example, a value in a range from 0.1 times the length L to 0.3 times the length L.

If YES in step S123, the process proceeds to step S130. On the other hand, if NO in step S123, the value of s is incremented by 1, and the process proceeds to step S120 again. If NO in step S123, the area of the unused portion is large. It should be noted that in step S120 at the second time, the job analysis processing described above is performed on the second job.

It should be noted that in the print control processing in the premise Pm1b, the processes from step S120 to step S122 are repeated three times, and YES is determined in step S123. Then, the processing in step S130 is performed. In addition, in the premise Pm1b, the number N of ink regions calculated immediately before the processing in step S130 is performed is 2.

It should be noted that a configuration in which the upper limit Un of the number N of ink regions is set based on the performance of the printer, the installation conditions of the printer, and the like may be used. In this configuration, when the value of N is the upper limit Un and the size Df is larger than the specified value Th1, for example, the following processing is performed.

In the processing, among all the print target images corresponding to all the received jobs, a plurality of print target images having the smallest value of the size Df are set as images for generating the connection image Gw. Then, the process proceeds to step S130.

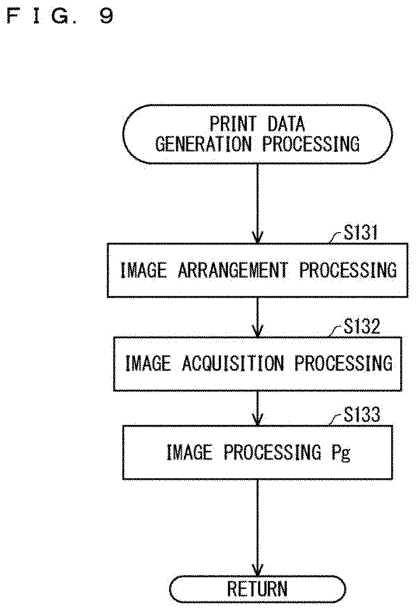

In step S130, print data generation processing is performed. The print data generation processing is processing for generating print data (image) used in the printing processing P. FIG. 9 is a flowchart of the print data generation processing.

In the print data generation processing, first, in step S131, image arrangement processing is performed. In the image arrangement processing, using a plurality of print target images, the image generation control unit 22 generates a connection image Gw indicating the plurality of print target images. Specifically, the image generation control unit 22 generates a connection image Gw in which the received plurality of print target images are arranged in the sub-scanning direction in the order of reception. Thus, in the generated connection image Gw, a plurality of print target images are arranged along the sub-scanning direction. In addition, the size of the generated connection image Gw is larger than the size of the region Rt1.

It should be noted that the plurality of print target images are arranged at intervals. The interval is an interval secured for cutting the paper 2 when the printing processing P is performed. It should be noted that all the intervals are set such that the lengths in the direction Drp of all the intervals included in the connection image Gw are not more than the size Df. It should be noted that a plurality of print target images may be arranged without any interval.

In addition, the image generation control unit 22 sets a cut position on each print target image indicated by the connection image Gw. Hereinafter, the connection image Gw generated by the image arrangement processing is also referred to as “original connection image Gw”.

In the image arrangement processing in the premise Pm1b, as shown in FIG. 5, a connection image Gw in which the images G1, G2, and G3 are arranged is generated. In addition, the cut position is set to a position indicated by a dotted line in FIG. 5. Hereinafter, an image that can be generated by printing processing P in one time is also referred to as a “unit image”. The unit image is an image that can be generated using one ink region R10.

Next, in step S132, image acquisition processing is performed. In the image acquisition processing, N unit images are acquired from the connection image Gw in consideration of the joint region Rw. When N is 2, one joint region Rw exists in the connection image Gw.

In the image acquisition processing in the premise Pm1b, the image processing unit 23 generates an image Gwa and an image Gwb as unit images using the connection image Gw. Specifically, the image processing unit 23 acquires an image Gwa and an image Gwb as unit images from the connection image Gw (see FIGS. 6, 7A, 7B, and 7C).

Next, in step S133, image processing Pg is performed. In the image processing Pg, the image working unit 24 performs image processing for reducing the density change of the joint region Rw, which occurs when the end portion Gbe is superimposed on the end portion Gae, on the end portion Gae and the end portion Gbe. That is, the image processing Pg is processing of correcting the end portion Gae and the end portion Gbe so as to suppress a decrease in image quality of the joint region Rw, which occurs when the end portion Gbe is superimposed on the end portion Gba.

The image processing Pg is processing disclosed in Japanese Patent Application Laid-Open No. 2016-182783, for example. In the following, the image processing Pg will be briefly described.

Hereinafter, an image whose density gradually changes in the sub-scanning direction is also referred to as “gradation image”. In addition, hereinafter, the end portion Gae in which the density of the end portion Gae gradually decreases from the front end Gae1 toward the rear end Gae2 of the end portion Gae in FIG. 7B is also referred to as “end portion Gar”. The end portion Gar is a gradation image. In addition, hereinafter, the end portion Gbe in which the density of the end portion Gbe gradually increases from the front end Gbe1 toward the rear end Gbe2 of the end portion Gbe in FIG. 7C is also referred to as “end portion Gbr”. The end portion Gbr is a gradation image.

Specifically, in the image processing Pg, the image working unit 24 corrects the densities (gradation values) of a plurality of pixels included in the end portion Gae so that the end portion Gae of the image Gwa becomes the end portion Gar (gradation image). In addition, the image working unit 24 corrects the densities (gradation values) of a plurality of pixels included in the end portion Gbe so that the end portion Gbe of the image Gwb becomes the end portion Gbr (gradation image).

When the end portion Gbe is superimposed on the end portion Gae, the end portion Gae and the end portion Gbe are corrected by the image processing Pg so that a color tone equivalent to the color tone of the joint region Rw included in the original connection image Gw described above can be reproduced.

Hereinafter, the state of the image Gwa having the end portion Gae corrected by the image processing Pg is also referred to as “corrected state”. In addition, hereinafter, the state of the image Gwb having the end portion Gbe corrected by the image processing Pg is also referred to as “corrected state”.

Performing the above-described print data generation processing (steps S131, S132, and S133) generates print data. The print data generated by the print data generation process in the premise Pm1b is data indicating an image Gwa in a corrected state and an image Gwb in a corrected state. Then, the image processing Pg ends and the print data generation processing also ends, and the process proceeds to step S140 of the print control processing in FIG. 8.

In step S140, printing processing Pw is performed. In the printing processing Pw, printing processing P in N times are performed. In the printing processing Pw in the premise Pm1b, the printing processing P is performed twice. The print control unit 21 performs processing for printing the image Gwa on the paper 2 using the region Rt1a in the n-th printing processing P. In addition, the print control unit 21 performs processing for printing the image Gwb on the paper 2 using the region Rt1b in the (n+1)-th printing processing P.

Specifically, the print control unit 21 controls the printing unit 30 using the print data so that the first printing processing P and the second printing processing P are performed in the order of the first printing processing P and the second printing processing P. The first printing processing P is processing for printing the image Gwa in the corrected state on the paper 2 using the region Rt1a. In addition, the second printing processing P is processing for printing the image Gwb in the corrected state on the paper 2 using the region Rt1b.

In addition, the print control unit 21 controls the printing unit 30 so that the operation of printing the image Gwb is performed in the second printing processing P. Specifically, the print control unit 21 controls the printing unit 30 so that in the second printing processing P, a printing operation of the image Gwb for superimposing the end portion Gbe of the image Gwb in the corrected state on the end portion Gae of the image Gwa in the corrected state. It should be noted that since the printing processing P has been described above, the description thereof will be omitted.

Performing the printing processing Pw in the premise Pm1b prints the connection image Gw indicating the images G1, G2, and G3 in FIG. 5 on the paper 2. That is, the images Gwa and Gwb for expressing the connection image Gw are a plurality of images for printing, in the printing processing P in two times, the connection image Gw indicating the images G1, G2, and G3. Hereinafter, the state of the paper 2 on which the connection image Gw is printed is referred to as “print state”.

Next, in step S150, cutting processing is performed. In the cutting processing, the print control unit 21 controls the printing unit 30 so that the cutter CT1 cuts the cut position, of the paper 2 in the print state, set on each image indicated by the connection image Gw. Thus, a plurality of pieces of printed matter are generated. Each piece of the printed matter is the paper 2 on which an image is printed. Then, the plurality of pieces of printed matter are sequentially discharged from the printer 100. Then, the print control processing ends.

### Summary

As described above, according to the present embodiment, the image generation control unit 22 generates the connection image Gw indicating the images G1, G2, and G3. The connection image Gw is an image for being printed using the region Rt1a for being used in the n-th printing processing and the region Rt1b for being used in the (n+1)-th printing processing. The image processing unit 23 generates an image Gwa for being printed using the region Rt1a and an image Gwb for being printed using the region Rt1b.

Thus, the effect is obtained that it is possible to generate a plurality of images (images Gwa and Gwb) for printing, by the printing processing in a plurality of times, a large image (connection image Gw) indicating a plurality of printing target images (images G1, G2, and G3).

In the present embodiment, when a plurality of print target images having a half excess size are printed, unused portions not used in the comparative example can be effectively used. Therefore, the used amount of the ink sheet 6 can be reduced as compared with that in the comparative example. As a result, the effect that the printing cost can be reduced is obtained.

In addition, in the present embodiment, image processing Pg is performed for correcting the end portion Gae and the end portion Gbe so as to suppress a decrease in image quality of the joint region Rw, which occurs when the end portion Gbe is superimposed on the end portion Gae. Thus, an effect is obtained that printed matter with quality higher than that in a configuration where the image processing Pg is not performed can be obtained.

It should be noted that in the print control processing of the present embodiment, processing has been described in which the images G1, G2, and G3 having sizes smaller than the size of the region Rt1 of the ink sheet 6 are used as print target images. However, the print control processing of the present embodiment can also be applied to an image having a size larger than the size of the region Rt1. That is, the print control processing of the present embodiment can also be applied to a plurality of images of any size. Therefore, according to the print control processing of the present embodiment, it is possible to print a plurality of images of any size regardless of the size of the region Rt1 of the ink sheet 6.

It should be noted that in the related configuration A described above, if the sizes of the first and second images are sizes half the size of the region Rt1 of the ink sheet, two-image printing processing is performed. For example, if the size of the first and second images is 6×4 size and the size of the region Rt1 is 6×8 size, the two-image printing processing is performed.

In the two-image printing processing, the first image is printed using a half of the region Rt1. Thereafter, rewinding processing of the ink sheet is performed. Then, the second image is printed using another half of the region Rt1.

However, in the related configuration A, when the size of the first image is a half excess size, the printer does not perform the rewinding processing of the ink sheet. For example, when the size of the first image is 6×5 size and the size of the region Rt1 is 6×8 size, the printer does not perform the rewinding processing. In this case, a large unused portion exists in the region Rt1. Therefore, in the related configuration A, when the size of the first image is a half excess size, there is a problem that the region Rt1 cannot be effectively used in printing the image.

Thus, the printer 100 of the present embodiment has a configuration for achieving the above-described effect. Therefore, the above problem can be solved by the printer 100 of the present embodiment.

### First Modification

Hereinafter, the configuration of the first embodiment is also referred to as “configuration Ct1”. In addition, hereinafter, the configuration of the present modification is also referred to as “configuration Ctm1”. The configuration Ctm1 is a configuration in which the positions of at least some of the plurality of print target images are changed based on the joint region Rw. The configuration Ctm1 is applied to the configuration Ct1 (first embodiment).

In the configuration Ctm1, the print control processing in FIG. 8 is performed as in the first embodiment. It should be noted that in the print control processing in FIG. 8 to which the configuration Ctm1 is applied, in step S130, print data generation processing to which the configuration Ctm1 is applied is performed.

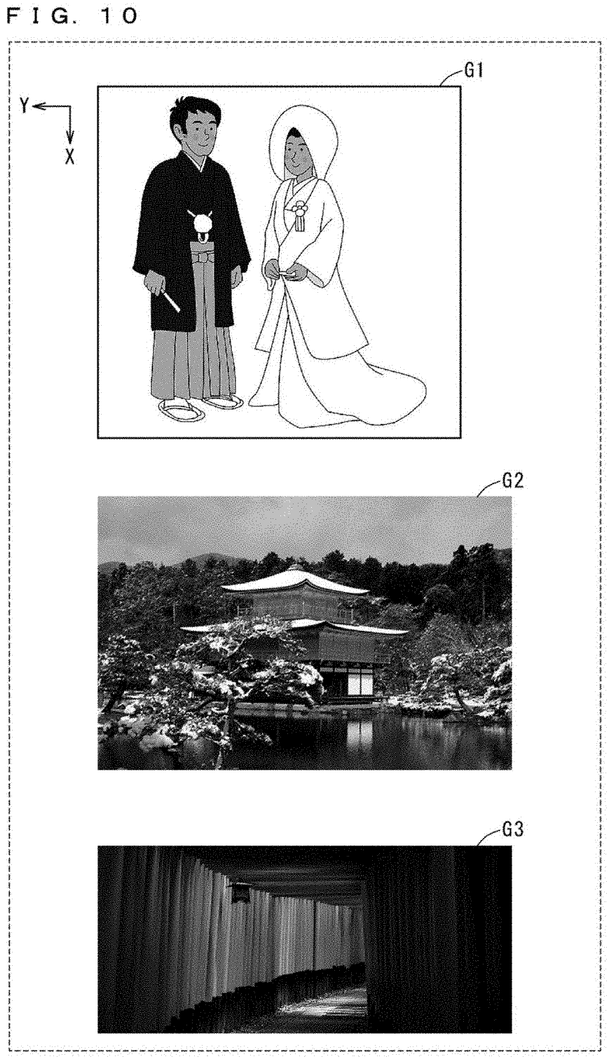

Here, the following premise Pm1c is considered. In the premise Pm1c, the information processing apparatus 200 sequentially transmits three respective jobs corresponding to three print target images to the printer 100. In the premise Pm1c, the three print target images are, for example, the images G1, G2, and G3 in FIG. 10.

In the print control processing in the premise Pm1c, steps S110, S120, S121, S122, S123, and S130 are performed as in the first embodiment. In step S130, print data generation processing to which the configuration Ctm1 is applied according to the first modification is performed.

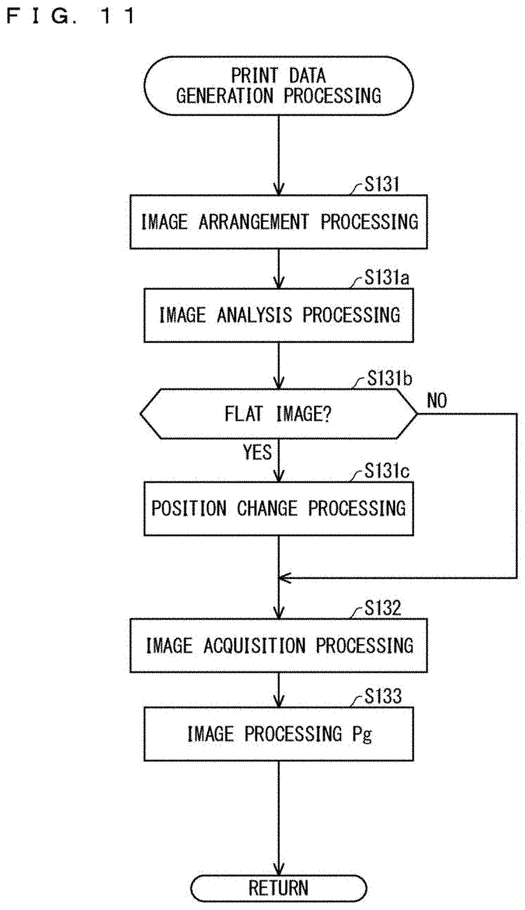

FIG. 11 is a flowchart of print data generation processing according to the first modification. In FIG. 11, since the processing in the step number same as the step number in FIG. 9 is performed in the same manner as the processing described in the first embodiment, the detailed description will not be repeated. In the following, points different from those in the first embodiment will be mainly described.

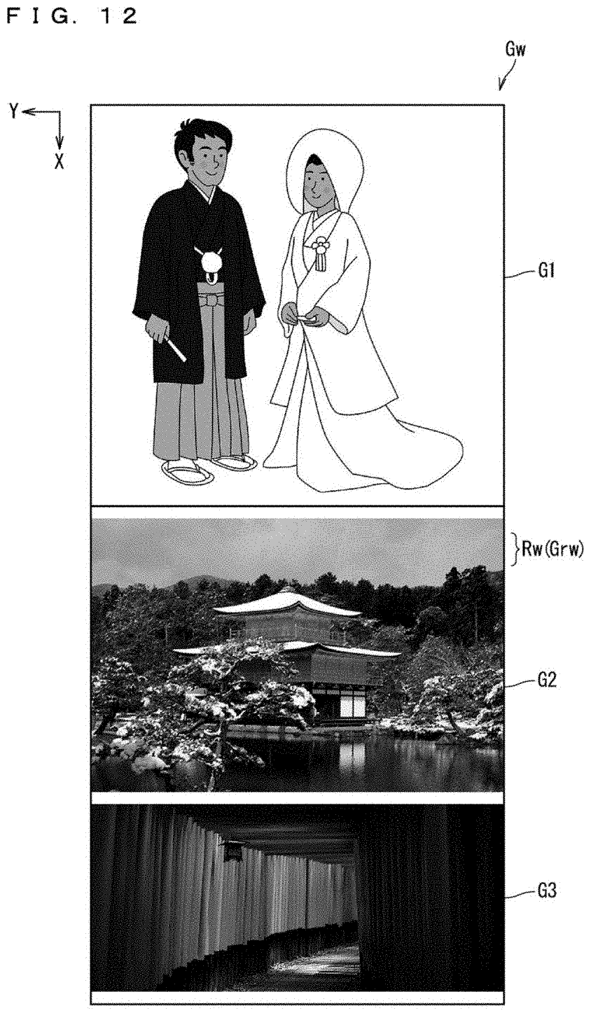

In step S131, image arrangement processing is performed as in the first embodiment. Performing the image arrangement processing in the premise Pm1c generates a connection image Gw in which the images G1, G2, and G3 are arranged as shown in FIG. 12. Hereinafter, an image in the joint region Rw of the connection image Gw is also referred to as “joint image Grw”.

Next, in step S131a, image analysis processing is performed. In the image analysis processing, the image generation control unit 22 analyzes one or more print target images (joint images Grw) included in a plurality of print target images (images G1, G2, and G3). Specifically, the image generation control unit 22 analyzes the joint region Rw (joint image Grw). The analysis is performed by processing of extracting a high-frequency component of an image using a two-dimensional Fourier transform, for example.

Then, the image generation control unit 22 determines whether the joint image Grw is a flat image. The flat image is an image that does not include a high-frequency component, for example. The high-frequency component is an edge or the like, for example. In addition, the flat image is an image having a low density, for example.

It should be noted that the determination as to whether or not the joint image Grw is a flat image is performed using the following determination condition. The determination condition is, for example, a condition that a ratio of a high-frequency component included in the joint image Grw is 10% or more. In addition, the determination condition is, for example, a condition that the average value of the densities of a plurality of pixels forming the joint image Grw is 0.7 times or more the maximum density. The maximum density is the highest density that a pixel can express.

If the above-described determination condition is satisfied, the image generation control unit 22 determines that the joint image Grw is not a flat image. If the determination condition is not satisfied, the image generation control unit 22 determines that the joint image Grw is a flat image.

If the joint image Grw is a flat image, the joint between two adjacent images generated in the joint region Rw is likely to be noticeable. Thus, in the present modification, if the joint image Grw is a flat image, the following processing is performed to make the joint less noticeable.

First, in step S131b, if the joint image Grw is a flat image (YES in step S131b), the process proceeds to step S131c. On the other hand, if the joint image Grw is not a flat image (NO in step S131b), the process proceeds to step S132.

In the premise Pm1c, the joint image Grw is a flat image indicating the sky included in the image G2 in FIG. 12. Therefore, the process proceeds to step S131c.

In step S131c, position change processing is performed. In the position change processing, to sum up, in order that the flat image is not arranged in the joint region Rw, the image generation control unit 22 replaces the position of the print target image including the flat image with the position of the replacement target image described below.

Hereinafter, of a plurality of print target images included in the connection image Gw, the print target image including the joint image Grw is also referred to as “print target image A”. The print target image A in FIG. 12 is an image G2, for example. In addition, hereinafter, of a plurality of print target images included in the connection image Gw, the print target image not including the joint image Grw is also referred to as “print target image An”. The print target images An in FIG. 12 are images G1 and G3, for example.

The replacement target image in the position change processing is a print target image An. Hereinafter, a state in which the position of the print target image A and the position of the print target image An are replaced is also referred to as “replacement state”. In addition, hereinafter, an image in the joint region Rw in the replacement state is also referred to as “joint image Grwx”.

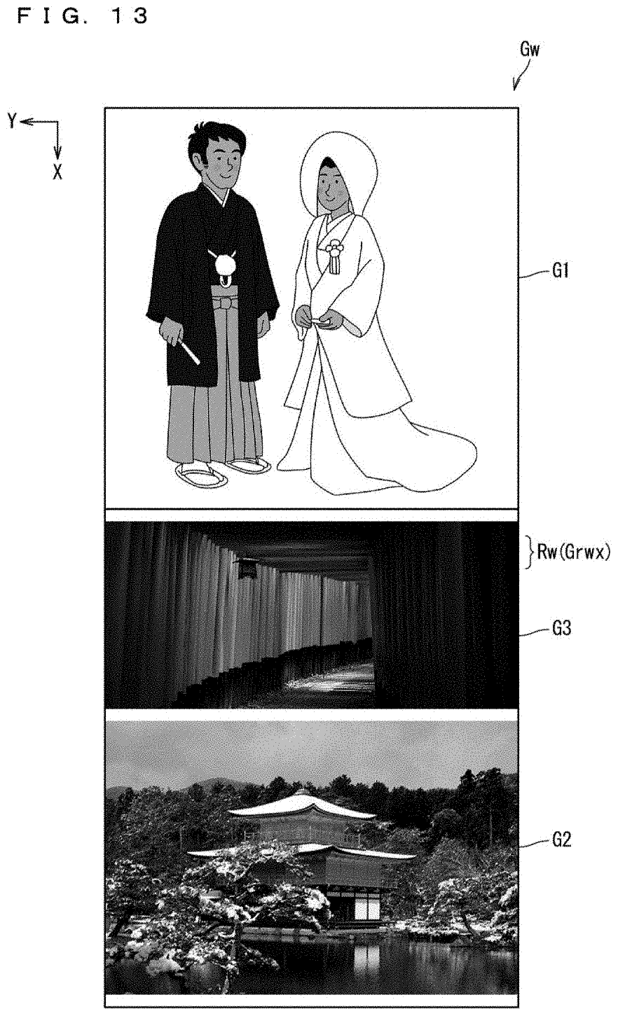

Next, the position change processing will be described in detail. In the position change processing, first, analysis processing is performed. In the analysis processing, the joint image Grwx is analyzed. For example, the joint image Grwx in a state where the position of the image G2 and the position of the image G3 are replaced is an image in the joint region Rw included in the image G3 in FIG. 13. When there are a plurality of print target images An, the analysis of the joint image Grwx is also performed a plurality of times. Since the analysis of the joint image Grwx is the same as the image analysis processing in step S131a, detailed description will not be repeated.

In the analysis processing in the premise Pm1c, first, the image generation control unit 22 analyzes the joint image Grwx in a state where the position of the image G2 and the position of the image G1 are replaced. Next, the image generation control unit 22 analyzes the joint image Grwx in a state where the position of the image G2 and the position of the image G3 are replaced. The joint image Grwx is the joint image Grwx in FIG. 13.

Next, in the position change processing, specifying processing is performed. In the specifying processing, the image generation control unit 22 specifies an optimal joint image Grwx. The optimum joint image Grwx is an image closest to the goal image. The goal image is an image that makes the joint of the joint region Rw less noticeable. The goal image is, for example, an image in which the ratio of the high-frequency component included in the joint image Grwx is 80% or more. In addition, the goal image is, for example, an image in which the average value of the densities of a plurality of pixels forming the joint image Grwx is 0.7 times or more the maximum density.

In the specifying processing in the premise Pm1c, the image generation control unit 22 specifies, as the optimum joint image Grwx, the joint image Grwx in FIG. 13 in a state where the position of the image G2 and the position of the image G3 are replaced. The joint image Grwx in FIG. 13 is an image in which the density of the entire joint image Grwx is high. In addition, the joint image Grwx is an image including many high-frequency components (such as edges).

Next, in the position change processing, position replacement processing is performed. In the position replacement processing, the image generation control unit 22 replaces the position of the image G2 and the position of the image G3 so that the connection image Gw includes the optimum joint image Grwx. Thus, the connection image Gw in FIG. 13 is generated. Therefore, the joint of the joint region Rw can be made less noticeable. Then, the position replacement processing ends, and the position change processing also ends.

Performing steps S131a, S131b, and S131c described above causes the image generation control unit 22 to analyze one or more print target images (joint images Grw) included in a plurality of print target images. The image generation control unit 22 changes the positions of at least some of the plurality of print target images in the connection image Gw according to the result of the analysis. That is, the above-described position change processing (S131c) is performed.

Thereafter, similarly to the first embodiment, the processes in and after step S132 are performed.

As described above, according to the present modification, the image generation control unit 22 analyzes one or more print target images (joint images Grw) included in a plurality of print target images. The image generation control unit 22 changes the positions of at least some of the plurality of print target images in the connection image Gw according to the result of the analysis. Thus, the joint of the joint region Rw can be made less noticeable. Therefore, the configuration Ctm1 of the present modification can further suppress a decrease in image quality of the joint region Rw as compared with that of the first embodiment. As a result, printed matter with high quality can be obtained.

It should be noted that in the above-described position change processing, a method for replacing a plurality of print target images is not limited to the above-described method (processing). The method for replacing a plurality of print target images may be any method as long as it makes the joint of the joint region Rw less noticeable.

### Second Modification

Hereinafter, the configuration of the present modification is also referred to as “configuration Ctm2”. The configuration Ctm2 is a configuration that generates a connection image Gw according to image generation information corresponding to the operation mode of the printer 100. The configuration Ctm2 is applied to all or a part of the configuration Ct1 (first embodiment) and the configuration Ctm1 (first modification).

In the configuration Ctm2, the printer 100 has a plurality of operation modes for outputting printed matter with different quality. One operation mode of the plurality of operation modes is set in the printer 100.

In the configuration Ctm2, an image generation definition table Tb1 is stored in the storage unit 10 of the printer 100. The image generation definition table Tb1 indicates image generation information corresponding to each operation mode.

The printer 100 has, as operation modes, for example, an ultra-high image quality mode, an image quality priority mode, a cost priority mode, and a speed priority mode. Each of the ultra-high image quality mode, the image quality priority mode, the cost priority mode, and the speed priority mode is properly used depending on the use of the user, the purpose of printing, and the like. Each of the ultra-high image quality mode, the image quality priority mode, the cost priority mode, and the speed priority mode is an operation mode for outputting printed matter with different quality.

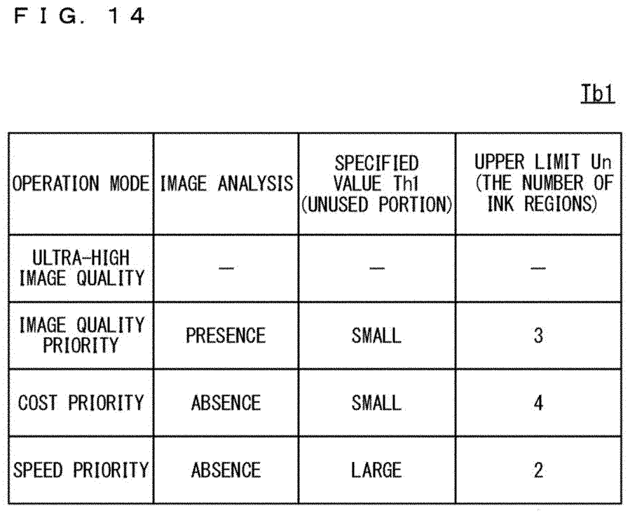

FIG. 14 is a diagram illustrating an example of the image generation definition table Tb1. Referring to FIG. 14, the image generation definition table Tb1 shows four pieces of image generation information as an example. Each piece of image generation information is defined by a plurality of parameters (items) arranged in the row direction in the image generation definition table Tb1. Four pieces of image generation information correspond to the respective four operation modes. Each of the four pieces of image generation information indicates different parameters related to generation of the connection image Gw and generation of a plurality of images for expressing the connection image Gw. The plurality of images for expressing the connection image Gw are, for example, an image Gwa and an image Gwb.

Each piece of image generation information indicated by the image generation definition table Tb1 indicates parameters of a corresponding one of the item “image analysis”, the item “specified value Th1”, and the item “upper limit Un”.

In the image generation definition table Tb1, “image analysis” indicates whether to perform the “image analysis processing” of the first modification. “PRESENCE” is a parameter for causing the image generation control unit 22 to perform the characteristic processing of the first modification. That is, when “PRESENCE” is indicated in the item “image analysis”, “image analysis processing” and “position change processing” or the like related to “image analysis processing” are performed. Thus, a decrease in image quality of the joint region Rw is suppressed. “ABSENCE” is a parameter for causing the image generation control unit 22 not to perform the characteristic processing of the first modification.

The “specified value Th1” is a value for determining the area of the unused portion, as described above. The smaller the specified value Th1, the smaller the area of the unused portion. It should be noted that when the specified value Th1 is small, the arrangement state of the plurality of print target images is more appropriate. The larger the specified value Th1, the larger the area of the unused portion.

The “upper limit Un” is an upper limit of the number N of ink regions as described above. That is, the upper limit Un is an upper limit of the number of ink regions R10 used for printing k print target images on the paper 2.

The ultra-high image quality mode is a mode used for obtaining the printed matter with the highest quality. In the ultra-high image quality mode, it is required that no density step or the like occurs at the joint region Rw. In the ultra-high image quality mode, the characteristic processing (such as print data generation processing) of the print control processing described in the first embodiment and the like is not performed. That is, the ultra-high image quality mode is a mode in which one print target image is printed using one ink region R10. The ultra-high image quality mode is also referred to as portrait mode.

The image quality priority mode is a mode used for performing a normal photographic print or the like and for obtaining printed matter with high quality. In the image quality priority mode, the image generation control unit 22 performs the characteristic processing of the first modification. In the image quality priority mode, the upper limit of the number of the ink regions R10 is set to a standard value (3).

The cost priority mode is a mode used in a situation where a large amount of printing needs to be performed, for example. The cost priority mode is used in a situation where the quality of the printed matter is not required. The cost priority mode is used when an advertisement, direct mail, and the like are printed, for example. In the cost priority mode, the image generation control unit 22 does not perform the characteristic processing of the first modification. In addition, in the cost priority mode, the area of the unused portion is set to be small. In addition, in the cost priority mode, the upper limit of the number of the ink regions R10 is set to a larger value (4).

The speed priority mode is a mode used in a situation where it is necessary to provide the printed matter to a customer as soon as possible, for example. In the speed priority mode, the image generation control unit 22 does not perform the characteristic processing of the first modification. In the speed priority mode, since the area of the unused portion may be large, the specified value Th1 is set to a large value. In addition, in the speed priority mode, the upper limit of the number of the ink regions R10 is set to the minimum value (2) in order to shorten the time required for outputting printed matter.

Next, processing performed in the configuration Ctm2 will be briefly described. In the configuration Ctm2, the information processing apparatus 200 transmits mode setting instructions to the printer 100 in addition to the image data D1. The mode setting instructions are instructions for setting an operation mode of the printer 100. The mode setting instructions indicate any one of the ultra-high image quality mode, the image quality priority mode, the cost priority mode, and the speed priority mode.

In response to receiving the mode setting instructions, the printer 100 sets the operation mode of the printer 100 to the operation mode indicated by the mode setting instructions. Hereinafter, the operation mode set in the printer 100 is also referred to as “set operation mode”. In addition, hereinafter, of the plurality of pieces of image generation information indicated by the image generation definition table Tb1, the image generation information corresponding to the set operation mode is also referred to as “corresponding image generation information”.

Next, the image generation control unit 22 generates a connection image Gw based on the corresponding image generation information (parameters). It should be noted that the image generation control unit 22 performs the print data generation processing of the first embodiment or the first modification based on the corresponding image generation information (parameters), thereby generating the connection image Gw.

In addition, the image processing unit 23 generates a plurality of images for expressing the connection image Gw based on the corresponding image generation information (parameters). The plurality of images for expressing the connection image Gw are, for example, an image Gwa and an image Gwb.

For example, when the mode setting instructions indicate “speed priority mode”, the printer 100 sets the operation mode of the printer 100 to the speed priority mode. Then, in the print data generation processing (S130), the image generation control unit 22 generates the connection image Gw with the above-described image arrangement processing (S131) based on the image generation information (parameters) corresponding to the speed priority mode indicated by the image generation definition table Tb1. In this case, the image generation control unit 22 does not perform the image analysis processing and the like of the first modification.

In addition, in the print data generation processing (S130), the image processing unit 23 generates an image Gwa and an image Gwb with the above-described image acquisition processing (S132) based on the image generation information (parameters) corresponding to the speed priority mode indicated by the image generation definition table Tb1.

Then, similarly to the first embodiment, the processes in and after step S140 are performed.

As described above, according to the present embodiment, the operation mode of printer 100 can be switched by the mode setting instructions transmitted by the information processing apparatus 200. For example, the image generation control unit 22 generates the connection image Gw based on the corresponding image generation information (parameters) corresponding to the set operation mode. In addition, the image processing unit 23 generates a plurality of images (image Gwa and image Gwb) for expressing the connection image Gw based on the corresponding image generation information (parameters).

Thus, the printer 100 can perform printing suitable for the use by the user, the purpose of printing, and the like. That is, user convenience can be improved in printing images. It should be noted that also in the present modification, an effect as in the first embodiment can be obtained.

### Second Embodiment

Hereinafter, the configuration of the second embodiment is also referred to as “configuration Ct2”. The configuration Ct2 is a configuration in which the information processing apparatus 200 performs print data generation processing.

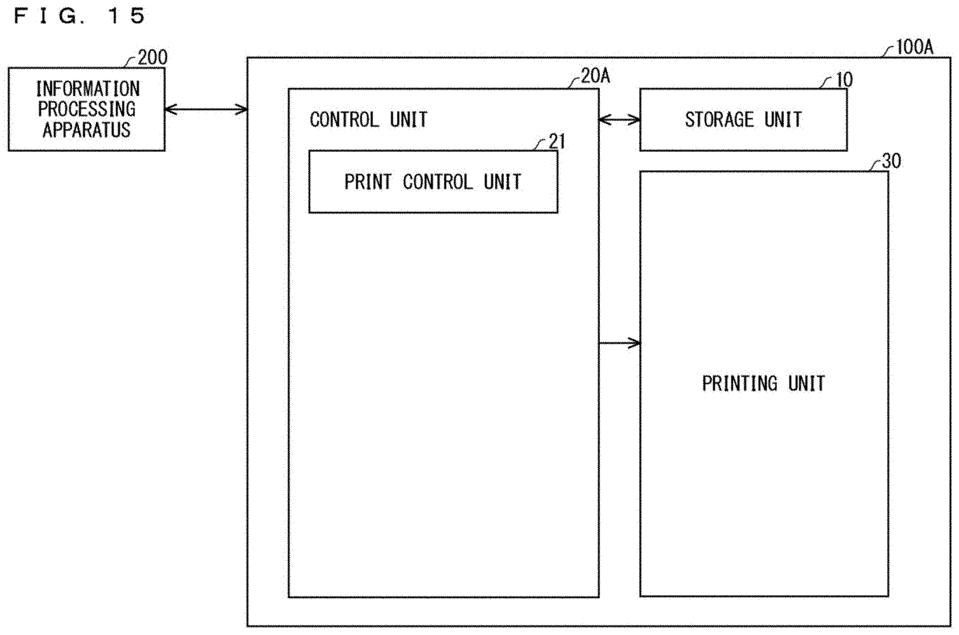

FIG. 15 is a block diagram showing a main configuration of a printer 100A according to the second embodiment. The printer 100A is different from the printer 100 in FIG. 1 in that a control unit 20A is included instead of the control unit 20. Since the configuration and function of the printer 100A other than that are the same as those of the printer 100, detailed description will not be repeated.

The control unit 20A is different from the control unit 20 in that the control unit 20A does not include the image generation control unit 22, the image processing unit 23, and the image working unit 24. Since the configuration and function of the control unit 20A other than those are the same as those of the control unit 20, detailed description will not be repeated.

Next, processing in the configuration Ct2 will be described. In the configuration Ct2, the information processing apparatus 200 performs steps S120, S121, and S122 of the print control processing in FIG. 8 until YES is determined in step S123 in the same manner as in the first embodiment. Next, the information processing apparatus 200 performs the print data generation processing in step S130 in the same manner as in the first embodiment. That is, the information processing apparatus 200 performs the processing in steps S131, S132, and S133 in FIG. 9 in the same manner as in the first embodiment. In other words, the information processing apparatus 200 performs the image arrangement processing, the image acquisition processing, and the image processing Pg.

Thus, the information processing apparatus 200 generates print data. The print data is, for example, data indicating the image Gwa in the above-described corrected state and the image Gwb in the above-described corrected state. In addition, the print data includes linked print information and variable length print information. The linked print information is information for causing the printer 100A to execute the printing processing Pw in step S140. The variable length print information is information for causing the printer 100A to execute the cutting processing in step S150.

Then, the information processing apparatus 200 transmits the generated print data to the printer 100A. The printer 100A performs the processing in steps S140 and S150 in response to receiving the print data in the same manner as in the first embodiment.

As described above, according to the present embodiment, for example, when performing an operation for generating jobs in the information processing apparatus 200, the user can check a process in the middle of the processing for generating print data via the application software or the like.

Therefore, the user can adjust the content of the job so that the ink sheet can be used efficiently. In addition, the user can adjust various types of parameters and the like so as to obtain printed matter having appropriate image quality.

### Functional Block Diagram

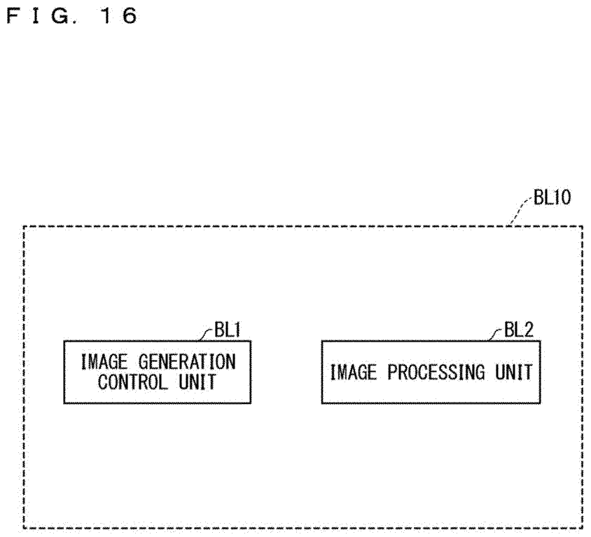

FIG. 16 is a block diagram illustrating a characteristic functional configuration of a printer BL10. The printer BL10 corresponds to any one of the printer 100 and the printer 100A. In other words, FIG. 16 is a block diagram illustrating main functions related to the present invention, among the functions of the printer BL10.

The printer BL10 performs printing processing for printing an image using the ink sheet. The ink sheet includes a first region for being used in the n-th (natural number of one or more) printing processing and a second region for being used in the (n+1)-th printing processing. The printer BL10 performs processing using a plurality of print target images. The sizes of one or more print target images included in the plurality of print target images are different from the size of the first region.

The printer BL10 functionally includes an image generation control unit BL1 and an image processing unit BL2. The image generation control unit BL1 generates, using the plurality of print target images, a connection image being an image for being printed using the first region and the second region, the connection image indicating the plurality of print target images. The image generation control unit BL1 corresponds to the image generation control unit 22.

The image processing unit BL2 generates, using the connection image, a first image included in the connection image for being printed using the first region, and a second image included in the connection image for being printed using the second region. The image processing unit BL2 corresponds to the image processing unit 23.

### Other Modifications

As described above, the printer according to the present invention has been described based on each embodiment and each modification, but the present invention is not limited to each embodiment and each modification. Without departing from the gist of the present invention, those obtained by performing modifications conceived by those skilled in the art on each embodiment and each modification are also included in the present invention. In other words, in the present invention, each of the embodiments and each of the modifications can be freely combined, and each of the embodiments and each of the modifications can be appropriately modified or omitted within the scope of the present invention.

Hereinafter, the printer according to the present invention is also referred to as “printer hzs”. The printer hzs is any one of the printers 100 and 100A.

In addition, the printer hzs does not need to include all the components shown in the drawings. That is, the printer hzs has to include only the minimum components that can achieve the effects of the present invention.

In addition, each function of the image generation control unit 22 and the image processing unit 23 included in the printer 100 may be achieved by a processing circuit.

The processing circuit is a circuit for generating, using the plurality of print target images, a connection image being an image for being printed using the first region and the second region, the connection image indicating the plurality of print target images.

In addition, the processing circuit is also a circuit for generating, using the connection image, a first image included in the connection image for being printed using the first region, and a second image included in the connection image for being printed using the second region.

The processing circuit may be dedicated hardware. In addition, the processing circuit may be a processor that executes a program stored in a memory. The processor is, for example, a central processing unit (CPU), a central processing apparatus, an arithmetic apparatus, a microprocessor, a microcomputer, a digital signal processor (DSP), or the like.

Hereinafter, a configuration in which the processing circuit is dedicated hardware is also referred to as “configuration Cs1”. In addition, hereinafter, a configuration in which the processing circuit is a processor is also referred to as “configuration Cs2”. In addition, hereinafter, a configuration in which a function of each of the image generation control unit 22 and the image processing unit 23 is achieved by a combination of hardware and software is also referred to as “configuration Cs3”.

In the configuration Cs1, a single circuit, a composite circuit, a programmed processor, a parallel programmed processor, an application specific integrated circuit (ASIC), a field programmable gate array (FPGA), or a combination thereof corresponds to the processing circuit, for example. The functions of the image generation control unit 22 and the image processing unit 23 may be achieved by two respective processing circuits. In addition, all functions of the image generation control unit 22 and the image processing unit 23 may be achieved by one processing circuit.

It should be noted that a configuration in which all or a part of each component included in the printer 100 is represented by hardware is as follows, for example. Hereinafter, a printer in which all or a part of each component included in the printer 100 is represented by hardware is also referred to as “printer hd10”.

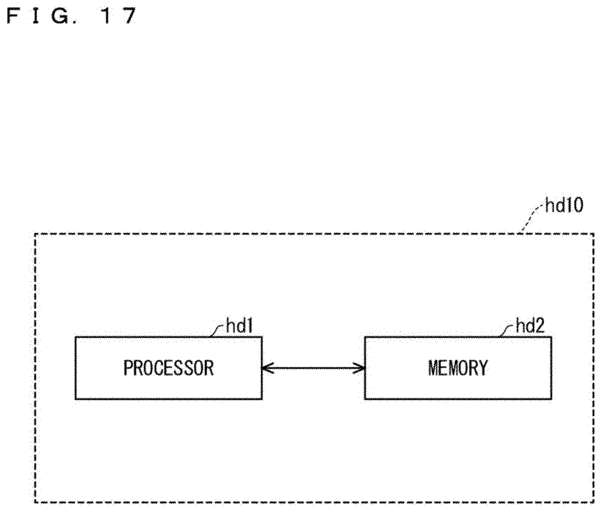

FIG. 17 is a hardware configuration diagram of the printer hd10. With reference to FIG. 17, the printer hd10 includes a processor hd1 and a memory hd2. The memory hd2 is a nonvolatile or volatile semiconductor memory such as a random access memory (RAM), a read only memory (ROM), a flash memory, an EPROM, and an EEPROM. In addition, the memory hd2 is, for example, a magnetic disk, a flexible disk, an optical disc, a compact disc, a mini disc, a DVD, or the like. In addition, the memory hd2 may be any storage medium used in the future.

In the configuration Cs2, the processing circuit is the processor hd1. In the configuration Cs2, a function of each of the image generation control unit 22 and the image processing unit 23 is achieved by software, firmware, or a combination of software and firmware. The software or firmware is described as a program and stored in the memory hd2.

In addition, in the configuration Cs2, reading the program stored in the memory hd2 and executing the program, by the processing circuit (processor hd1), achieves a function of each of the image generation control unit 22 and the image processing unit 23. That is, the memory hd2 stores the following program.

The program is a program for causing the processing circuit (processor hd1) to execute a step of generating, using the plurality of print target images, a connection image being an image for being printed using the first region and the second region, the connection image indicating the plurality of print target images.

In addition, the program is also a program for causing the processing circuit (processor hd1) to execute a step of generating, using the connection image, a first image included in the connection image for being printed using the first region, and a second image included in the connection image for being printed using the second region.

In addition, the program also causes a computer to execute a procedure of processing performed by each of the image generation control unit 22 and the image processing unit 23, a method of performing the processing, and the like.

In the configuration Cs3, part of functions of the image generation control unit 22 and the image processing unit 23 are achieved by dedicated hardware. In addition, in the configuration Cs3, another part of the functions of the image generation control unit 22 and the image processing unit 23 are achieved by software or firmware.

For example, the function of the image generation control unit 22 is achieved by the processing circuit reading and executing a program stored in the memory. In addition, for example, the function of the image processing unit 23 is achieved by a processing circuit as dedicated hardware.

As in the above configuration Cs1, configuration Cs2, and configuration Cs3, the processing circuit can achieve each function described above by hardware, software, firmware, or a combination thereof.

In addition, the present invention may be achieved as a print control method in which the operations of characteristic components included in the printer 100 are performed as steps. In addition, the present invention may be achieved as a program that causes a computer to execute each step included in the printing control method. In addition, the present invention may be achieved as a computer-readable recording medium that stores the program. In addition, the program may be delivered via a transmission medium such as the Internet.

In addition, the printing control method according to the present invention corresponds to the print control processing in FIG. 8, for example.

All the numerical values used in the above embodiments are exemplary numerical values for specifically describing the present invention. That is, the present invention is not limited to each of the numerical values used in the above embodiments.

It should be noted that in the present invention, each of the embodiments and each of the modifications can be freely combined, and each of the embodiments and each of the modifications can be appropriately modified or omitted within the scope of the present invention.

For example, in the above-described embodiments, the processing of printing the connection image Gw using two images (images Gwa and Gwb) and two types of ink regions R10 (region Rt1) has been described, but the present invention is not limited thereto. Three or more images may be acquired from the connection image Gw, and the connection image Gw may be printed using the three or more images and three or more types of ink regions R10 (region Rt1).

Although the present invention is described in detail, the above description is in all aspects illustrative, and the present invention is not limited to the above description. It is understood that innumerable modifications not illustrated can be envisaged without departing from the scope of the present invention.

### EXPLANATION OF REFERENCE SIGNS

6: ink sheet

20, 20A: control unit

21: print control unit

22, BL1: image generation control unit

23, BL2: image processing unit

24: image working unit

100, 100A, BL10, hd10: printer.

1. A printer configured to perform printing processing of printing an image using an ink sheet,
wherein the ink sheet has a first region for being used in the n-th (natural number of one or more) printing processing and a second region for being used in the (n+1)-th printing processing,
wherein the printer performs processing using a plurality of print target images, and
wherein a size of one or more print target images included in the plurality of print target images is different from a size of the first region,
the printer comprising:
an image generation control unit configured to generate, using the plurality of print target images, a connection image being an image for being printed using the first region and the second region, the connection image indicating the plurality of print target images; and
an image processing unit configured to generate, using the connection image, a first image included in the connection image for being printed using the first region, and a second image included in the connection image for being printed using the second region,
wherein the printer has a plurality of operation modes for outputting printed matter with different quality,
wherein a plurality of pieces of image generation information correspond to the respective plurality of operation modes,
wherein the plurality of operation modes includes an image quality priority mode, a cost priority mode, and a speed priority mode,
wherein each of the plurality of pieces of image generation information is information corresponding to the image quality priority mode, the cost priority mode, or the speed priority mode,
wherein each of the plurality of pieces of image generation information indicates a different parameter related to generation of the connection image, the first image, and the second image,
wherein in the printer, one operation mode of the plurality of operation modes is set,
wherein the image generation control unit generates the connection image based on corresponding image generation information being image generation information corresponding to a set operation mode being the operation mode being set among the plurality of pieces of image generation information, and
wherein the image processing unit generates the first image and the second image based on the corresponding image generation information.

2. The printer according to claim 1,
further comprising a print control unit,
wherein the print control unit performs processing for printing the first image using the first region in the n-th printing processing, and
wherein the print control unit performs processing for printing the second image using the second region in the (n+1)-th printing processing.

3. The printer according to claim 1,
wherein the connection image has a joint region, and
wherein the joint region is a region for superimposing a second end portion being a front end portion of the second image on a first end portion being a rear end portion of the first image,
the printer further comprising an image working unit configured to perform, on the first end portion and the second end portion, image processing for reducing a density change of the joint region occurring when the second end portion is superimposed on the first end portion.

4. The printer according to claim 3,
wherein in the connection image, the plurality of print target images are arranged along a sub-scanning direction,
wherein the image generation control unit analyzes one or more print target images included in the plurality of print target images, and
wherein the image generation control unit changes a position of at least some of the plurality of print target images in the connection image according to a result of the analysis.

5. (canceled)

6. A printing control method performed by an information processing apparatus configured to control a printer configured to perform printing processing for printing an image using an ink sheet, or by the printer,
wherein the ink sheet has a first region for being used in the n-th (natural number of one or more) printing processing and a second region for being used in the (n+1)-th printing processing,
wherein in the printing control method, processing using a plurality of print target images is performed, and
wherein a size of one or more print target images included in the plurality of print target images is different from a size of the first region,
the printing control method comprising:
a first generation step of generating, using the plurality of print target images, a connection image being an image for being printed using the first region and the second region, the connection image indicating the plurality of print target images; and
a second generation step of generating, using the connection image, a first image included in the connection image for being printed using the first region, and a second image included in the connection image for being printed using the second region,
wherein the printer has a plurality of operation modes for outputting printed matter with different quality,
wherein a plurality of pieces of image generation information correspond to the respective plurality of operation modes,
wherein the plurality of operation modes includes an image quality priority mode, a cost priority mode, and a speed priority mode,
wherein each of the plurality of pieces of image generation information is information corresponding to the image quality priority mode, the cost priority mode, or the speed priority mode,
wherein each of the plurality of pieces of image generation information indicates a different parameter related to generation of the connection image, the first image, and the second image, and
wherein in the printer, one operation mode of the plurality of operation modes is set,
the printing control method comprising a data generation step including at least the first generation step and the second generation step,
wherein the data generation step
(a1) generates the connection image based on corresponding image generation information being image generation information corresponding to a set operation mode being the operation mode being set among the plurality of pieces of image generation information, and
(a2) generates the first image and the second image based on the corresponding image generation information.

7. The printing control method according to claim 6,
wherein the printing control method is performed by the printer, and
wherein the printer includes a print control unit,
the printing control method further comprising a printing step for printing the first image and the second image,
wherein in the printing step,
the print control unit performs processing for printing the first image using the first region in the n-th printing processing, and
the print control unit performs processing for printing the second image using the second region in the (n+1)-th printing processing.

8. The printing control method according to claim 6,
wherein the connection image has a joint region, and
wherein the joint region is a region for superimposing a second end portion being a front end portion of the second image on a first end portion being a rear end portion of the first image,
the printing control method further comprising a step of performing, on the first end portion and the second end portion, image processing for reducing a density change of the joint region occurring when the second end portion is superimposed on the first end portion.

9. The printing control method according to claim 8,
wherein in the connection image, the plurality of print target images are arranged along a sub-scanning direction,
the printing control method further comprising:
a step of analyzing one or more print target images included in the plurality of print target images, and
a step of changing a position of at least some of the plurality of print target images in the connection image according to a result of the analysis.

10. (canceled)
